(19) United States
(12) Patent Application Publication
(10) Pub. No.: US 2011/0202762 A1
(43) Pub. Date: Aug. 18, 2011

(54) METHOD AND APPARATUS FOR CARRYING OUT SECURE ELECTRONIC COMMUNICATION

(75) Inventors: Isaac HADAD, Be'er Sheva (IL); Zvi Gam, Petach-Tikva (IL); Abraham Dahan, Rishon-LeZion (IL)

(73) Assignee: WALLETEX MICROELECTRONICS LTD.,, Hong Kong (CN)

(21) Appl. No.: 13/040,494

(22) Filed: Mar. 4, 2011

Related U.S. Application Data
(63) Continuation-in-part of application No. PCT/IL2009/000866, filed on Sep. 6, 2009.

(51) Int. Cl. G06F 21/00

(52) U.S. Cl. 713/164

(57) ABSTRACT

The present invention provides a system, method and device, for carrying out secure electronic communication over a computer network via a computer susceptible of being virus infected or eavesdropped by means of a personal apparatus comprising processing means, one or more memory devices, one or more interfacing means suitable for exchanging information with the insecure computer, and a communication software having cryptographic capabilities stored in the one or more memory means, wherein the personal apparatus is adapted to establish a secure channel with a remote computer over the computer network, by means of the insecure computer machine.

### FIELD OF THE INVENTION

The present invention relates to a new method and apparatus for carrying out secure and eavesdrop-free electronic communication via standard computer terminals, which might be susceptible of being virus infected or eavesdropped.

### BACKGROUND OF THE INVENTION

Electronic transactions are commonly carried out over data networks, such as the internet, by means of encryption cryptographic keys. For example; SSL or TLS protocols are widely used in online commerce wherein cardholders send their credit card details to a merchant over the internet. Other sets of protocols, such as SET (Secure Electronic Transaction), are employed for protecting merchants from theft by impersonators.

Conventionally, the communication between the parties involved in electronic transactions (e.g., bank transaction, e-commerce, and the like) is carried out over a data network directly between the transaction server (e.g., bank server) and the computer terminal used by the user, which is often susceptible to viruses and eavesdropping software and/or hardware. This situation is vulnerable to interception of secret information by potential eavesdroppers, such as computer hackers.

The electronic transaction infrastructures employed nowadays provide satisfactory protection against frauds and network level eavesdropping, but they do not protect users from eavesdropping in the computer terminals, as often done by means of Trojans (trojan horses—software designed by hackers to install a backdoor or a rootkit which enables them to access and collect data from the computer in which the Trojan was installed).

Any computerized system is susceptible to virus and computer hacking threats, but this lack of protection is particularly problematic when attempting to carry out electronic communication from publicly available computer terminals, such as available in Internet cafes and bars. The users employing such computer terminals can not ascertain that these terminals are eavesdropping/virus free. As explained hereinabove, users may establish secure (SSL or TLS) channels via such insecure computer terminals, over which electronic transactions may be securely carried out, but users' secret information (e.g., credit card numbers) may be intercepted by hackers if those terminals are infected/eavesdropped.

It is therefore an object of the present invention to provide a method and apparatus for carrying out secure and eavesdrop-free electronic transactions via a computerized system.

It is another object of the present invention to provide a method and apparatus for preventing interception of secret data transferred via computer terminals.

It is yet another object of the invention to provide a method and apparatus for passing secret information in a concealed and secured manner by means of conventional PC input devices.

Other objects and advantages of the invention will become apparent as the description proceeds.

### SUMMARY OF THE INVENTION

The inventors of the present invention developed new methods and apparatus for securely carrying out electronic communication over conventional data networks, such as the Internet, by means of insecure computer terminals. The present invention significantly increase the security of the electronic communication carried out and provides tamper-proof and eavesdrop-proof communication between the communicating parties (e.g., user's PC machine and a service provider's server, or PC machine of another user, which are generally related to herein as a computer terminal), which prevents any attempt to intercept, tamper with, or copy the information transferred between the communicating parties and any external intervention. The present invention may be advantageously used for carrying out electronic transactions (e.g., bank transactions, e-commerce, any transfer of confidential information between communicating parties over a data network).

The term communicating parties used herein generally refers to computerized systems between which the electronic communication is carried out. Such computerized machines may be for example, but not limited to, any suitable personal computers (PC), servers, and/or other devices having capabilities enabling them to establish data communication over conventional data networks (e.g., the Internet).

According to one preferred embodiment the electronic communication is carried out by means of a personal apparatus (also referred to herein as auxiliary apparatus or device, or smart card) capable of being connected to a computer terminal via a conventional I/O port (e.g., USB port) and capable of establishing secure communication (e.g., TLS or SSL) via said computer terminal with other parties over a data network, wherein said personal apparatus comprises processing and memory means, and optionally also keypad, keyboard, or other such input means, capable of receiving information from the user.

Preferably, the personal apparatus further comprises cryptographic means and/or secure processing and memory means. Optionally, the device may further comprise display means. Most preferably, the personal device is a type of chip card (e.g., smart card, such as described in WO 2007/138570), having optional keyboard/keypad input means and display means.

In this way secret data (e.g., private/confidential information, PIN, credit card number, account number, password, and the like), which is conventionally typed by the users by means of the computer terminal being used, is entered by the user via the personal apparatus by means of the keyboard/keypad provided therein, and it is transferred therefrom encrypted over a secure channel established between said personal apparatus and any other party involved in the electronic communication. Since the communication is performed over a secure channel established between the personal apparatus and the other communicating parties (e.g., bank server), the information transferred therebetween is not accessible to any eavesdropping/virus software/hardware which may reside in the computer terminal.

In a specific preferred embodiment of the invention the communication between the communicating parties is established by the personal apparatus by means of a networking software module installed in the computer terminal, or uploaded thereto from the personal apparatus upon connection. This networking software module is designed to identify the personal apparatus once it is connected to the computer terminal and provide it access to network resources of the computer terminal. The apparatus can authenticate (for example—by using PKI digital signatures or suitable protocols, such as the SSL protocol) the computer used by the other communicating party (e.g., bank server), and optionally the computer used by said communicating party can similarly authenticate the personal apparatus. In this way communication with wrong parties (e.g., impersonators), which may occur when an erroneous network address is typed by the user, is prevented.

The communication between the communicating parties may be carried out over an insecure channel until secret, confidential, and/or private information is required, and at this point the secret, confidential, and/or private information is entered by the user by means of the keypad/keyboard provided in the personal apparatus and transferred therefrom over a secure channel established between the personal apparatus and the other communicating party. The communication preferably involves a step of identifying the personal apparatus (e.g., by means of a unique identifier and/or electronic signature) by the communicating party thereby providing hardware identification and further user identification by requiring the user to type identifying information (e.g., PIN, password) by means of the keypad/keyboard provided in the personal apparatus.

In banking applications, for example, the access to user's account is preferably defined such that electronic transactions may be carried out only by means of the personal apparatus. Alternatively, the access may be defined such that electronic transactions are permitted only by means of the personal apparatus and user identification performed by verifying an identifying code (e.g., password, PIN) entered by the user via the keypad/keyboard provided in the personal apparatus, and transmitted therefrom over the secure channel. According to yet another alternative, the access may be defined such that electronic transactions are permitted once user identification is performed by verifying an identifying code (e.g., password, PIN) entered by the user via the keypad/keyboard provided in the personal apparatus, and transmitted therefrom over the secure channel, namely—without requiring hardware identification.

The personal apparatus may further comprise one or more biometric sensors (e.g., finger prints sensor) allowing it to authenticate users by comparing a biometric sample obtained from a user to a database of biometric samples stored in its memory. Alternatively or additionally, the biometric sample may be sent for to the remote computer with which the personal apparatus is communicating for authenticating the user according to a biometric database which may be maintained at the remote computer.

The network address of the remote computer with which the personal apparatus should communicate may be provided by the user via the computer terminal used, or alternatively, it may be stored in the memory of the personal apparatus. In a specific embodiment of the invention the communication carried out by means of the personal apparatus may be limited only to network addresses stored in its memory. Moreover, the personal apparatus may be adapted to authenticate the computer terminal to which it is being connected, and/or the remote computer, thereby limiting it to access only authorized computer machines.

According to another preferred embodiment of the invention the electronic communication is securely carried out between the user's computer terminal and the communicating party by means of graphical presentation of the information involved in the communication. More particularly, instead of transferring the information in the conventional way by means alphanumeric text symbols, images are generated by the communicating parties graphically incorporating the information in an OCR resistant form (in a machine non-readable form, such as in CAPTCHA challenges). In this way the information transferred by the communicating parties by means of such graphical representations remains concealed against eavesdropping threats.

According to yet another preferred embodiment of the invention the electronic communication is securely carried out between the user, using standard I/O means of the computer terminal, such as keyboard, mouse and display of the user's computer terminal, and the personal apparatus by means of graphical presentation of the information involved in the communication. More particularly, instead of transferring the information in the conventional way by means of alphanumeric text symbols typed by the user by means of a keyboard of the computer terminal, data entry images are generated by the apparatus graphically incorporating the information in an OCR resistant form (in a machine non-readable form, such as in CAPTCHA challenges). Inputs from the user to the auxiliary apparatus can be provided by pointing and clicking on the graphic images displayed on the screen—including alphanumeric and or graphic symbols images presented by graphic techniques - in this way the information transferred by the user to the auxiliary apparatus by indicating the relative locations in the displayed image over which the user “clicked” the pointing device. The auxiliary device, or the other communicating party, may then extract the secret information provided by the user using the information of the “clicked” locations, such that the secret information transferred by the user remains concealed against eavesdropping threats.

The graphical presentation of alphanumeric symbols in images is preferably further employed for securely entering and submitting secret data (e.g., PIN, credit card number) by means of a pointing device (e.g., mouse). This is preferably performed by means of an OCR resistant data entry image generated by the communicating party requesting the user's secret data, which image comprising a set of alphanumeric symbols. The user is provided with the image and requested to provide the secret data by moving the cursor over a sequence of symbols in the secret data appearing in the data entry image and clicking the pointing device thereon, or near it. The communicating party requesting this secret data then receives a sequence of relative locations (coordinates) within the data entry image generated by it designating the locations of symbols “clicked” by the user, said relative locations are then used to reveal the user's secret data.

Additionally or alternatively, such OCR resistant data entry images may be generated by the personal apparatus, if such apparatus is needed for the electronic communication. In this case the relative locations (coordinates) within the generated image are transferred to the personal apparatus and used by it to reveal the user's secret data.

Images may be further used for displaying the user possible options by incorporating into them graphical OCR proof textual representations of the options and allowing the user to perform graphical selection of the needed operation simply by “clicking” over the selected option in the image with a pointing device of the computer terminal. In a similar fashion, only the relative locations in the displayed image over which the user “clicked” the pointing device are transferred to the auxiliary apparatus over the I/O port, and/or to the other communicating party over the data network, such that the user's selection remains concealed against eavesdropping.

According to one aspect the present invention relates to a system for carrying out secure electronic communication over a computer network via a computer susceptible of being virus infected or eavesdropped, the system comprising a first computer (e.g., personal computer) coupled to said computer network, said first computer is susceptible of being virus infected or eavesdropped, a second computer operatively coupled to said computer network, and a personal apparatus comprising processing means, one or more memory devices, and one or more interfacing means suitable for exchanging information with the first computer, and a communication software having cryptographic capabilities stored in said one or more memory means, wherein the personal apparatus is adapted to establish a secure channel with the second computer over the computer network.

The computer network is preferably a TCP/IP network, or the Internet, and the second computer may be a transaction server (e.g., banking application server, e-commerce server). The secure channel may established after a request to establish secure channel is issued by a user client application (e.g., Internet browser), optionally following receipt and execution of a suitable script provided by the second computer. Preferably, the secured channel is implemented using the SSL protocol.

Preferably, a networking software module is activated (executed) in the first computer for providing the personal apparatus access to network resources of the first computer once it is connected thereto. Most preferably, the communication with the second computer is carried out in the personal apparatus by means of its communication application.

In one specific embodiment of the invention the communication with the second computer is carried out in the personal apparatus by means of its communication application, and by means of an interactive viewer executed in the first computer, wherein said interactive viewer is adapted to display the communication session of the communication application with the second computer, to receive user actions by means of the pointing device, and transfer said actions to the personal apparatus in form of relative locations in the display of the interactive viewer. The relative locations are then translated by the personal apparatus into actions according to locations clicked in the display.

The personal apparatus may further comprise a memory security chip. Advantageously, the personal apparatus may further comprise smart card capabilities. Data stored in the memory device of the personal apparatus is preferably stored in an encrypted form such that the processing means provided in the processing means is adapted to carry out data encryption/decryption.

The interfacing means of the personal apparatus may utilize conventional serial/parallel data communication ports and protocols (serial/parallel protocols such as USB), or wireless communication means (e.g., Bluetooth, WiFi, cellular CDMA, and the like). The physical (or wireless) and logical connection between the personal apparatus and the first computer by which data communication is established between them, is also referred to herein as linking or coupling.

The personal apparatus may further comprise data input means (e.g., keyboard or keypad), and in this case the data processing means is further adapted to receive data via the input means and transfer such data to the second computer over the secure channel. Additionally or alternatively, the personal apparatus may be further adapted to communicate secret data (e.g., PIN, password, credit card number, and the like) in a concealed manner by means of data entry images, said data entry images are generated by said personal apparatus or by said server and comprise alphanumeric and/or graphic symbols, wherein said secret data is transferred using relative locations of a sequence of alphanumeric and/or graphic symbols (i.e., the sequence of symbols from which the secret data is composed) appearing in said data entry image, as indicated by a user.

According to another aspect the present invention also aims to provide a method for carrying out secure electronic communication between a first computer and a second computer (e.g., transaction server) over a computer network (e.g., TCP/IP network), wherein said first computer is susceptible of being virus infected or eavesdropped, the method comprising the following steps:
linking a personal apparatus to the first computer, which personal apparatus comprising processing means, one or more memory devices, one or more interfacing means suitable for exchanging information with the first computer, and a communication software having cryptographic capabilities stored in said one or more memory means,
activating the communication software in said personal apparatus;
activating a networking software module in said first computer, which networking software module is adapted to provide the personal apparatus access to network resource provided in the first computer;
establishing communication with the second computer over the computer network by means of the communication software (e.g., a browser using HTTP, or another suitable protocol) and the networking software module;
establishing a secure channel with the second computer over the computer network; and
whenever needed sending data to the second computer from the personal apparatus over the secure channel.

The method may further comprise receiving data via input means provided in the personal apparatus and transferring the same, or parts of it, to the second computer over the secure channel. Alternatively or additionally, the method may further comprise the following steps:
generating data entry image by the personal apparatus or by the second computer, wherein the data entry image comprises alphanumeric and/or graphic symbols the relative locations of which in the data entry image are recorded in the personal apparatus or second computer;
displaying the data entry image in a display device provided in the first computer;
receiving in the first computer concealed data from a user by means of relative locations of a sequence of alphanumeric and/or graphic symbols appearing in the data entry image;
transferring the relative locations of a sequence of alphanumeric and/or graphic symbols appearing in the data entry image as indicated by the user to the personal apparatus and/or second apparatus; and
determining the data provided by the user according to the proximity of the relative locations of the sequence of alphanumeric and/or graphic symbols to the relative locations of alphanumeric and/or graphic symbols recorded in the personal apparatus or second computer. If the data entry image is generated by the personal apparatus, the determined data may be then sent from the personal apparatus to the second computer over the secure channel, if so needed.

Preferably, the data link between the first computer and the personal apparatus is established through conventional serial or parallel computer ports and protocols (e.g., serial/parallel ports, USB, and the like), or by means of wireless communication (e.g., Bluetooth, WiFi, cellular CDMA, and the like).

The networking software module may be provided to the first computer by the personal apparatus after linking between them. The method may further comprise executing an interactive viewer in the first computer, wherein said interactive viewer is adapted to display the communication session of the communication application with the second computer, to receive user actions by means of the pointing device, and transfer said actions to the personal apparatus in form of relative locations in the display of the interactive viewer. The relative locations are then translated by the personal apparatus into actions according to locations clicked in the display.

According to yet another aspect the present invention is also directed to a personal apparatus comprising: processing means; one or more memory devices; one or more interfacing means suitable for exchanging information with a computer terminal; a communication software having cryptographic capabilities stored in said one or more memory means; and optional input and/or display means, wherein the personal apparatus is adapted to communicate via the one or more interfacing means with a networking module executed in a computer terminal, the computer terminal being linked to a computer network, and wherein the personal apparatus is capable of establishing a secure channel (e.g., TLS or SSL) with a second computer over the computer network (e.g., the Internet) by means of the communication software. Advantageously, the personal apparatus may further comprises a memory security chip.

The apparatus may be adapted to communicate secret data in a concealed manner by means of data entry images generated by it to comprise alphanumeric and/or graphic symbols, wherein the secret data is transferred using relative locations of a set of alphanumeric and/or graphic symbols appearing in the data entry image as indicated by a user.

### BRIEF DESCRIPTION OF THE DRAWINGS

The present invention is illustrated by way of example in the accompanying drawings, in which similar references consistently indicate similar elements and in which:

FIGS. 1A and 1B schematically illustrates a system for carrying out secure and eavesdrop-free electronic transaction according to a preferred embodiments of the invention;

FIG. 2 schematically illustrates a possible chip card embodiment of the invention;

FIG. 3 exemplifies an image that may be used for delivering secret information in a concealed manner according to one preferred embodiment of the invention;

FIGS. 4A to 4D schematically illustrates implementations for securely transferring secret data to the transaction server, wherein FIG. 4A exemplifies a procedure wherein the secret data is provided via the auxiliary apparatus of the invention, FIG. 4B exemplifies a procedure wherein the entire transaction is carried out through the personal apparatus, FIG. 4C exemplifies a procedure wherein secret data is provided by indicating locations of alphanumeric symbols displayed in an image generated by the personal apparatus of the invention, and FIG. 4D exemplifies a similar procedure as in FIG. 4C but wherein the image is generated by the transaction server;

FIGS. 5A and 5B show confirmation images, wherein FIG. 5A exemplifies a confirmation image in which the user in asked to click over “OK” or “Cancel” graphics appearing the image, and FIG. 53 exemplifies a confirmation in which the user is asked to click a sequence of graphic symbols appearing in the image; and

FIGS. 6A and 6B show images respectively demonstrating secure selection of a desired action and secure provision of account number involved in the action.

### DETAILED DESCRIPTION OF PREFERRED EMBODIMENTS

The present invention is directed to a method and apparatus for carrying out secure and eavesdrop-free electronic communication over computer networks. The present invention substantially increase the security of electronic communication and thus its allows carrying out electronic communication over the internet by means of publicly accessible computer terminals, such as available to users in internet cafes and bars, which are generally considered to be insecure and susceptible to viruses and eavesdropping. These features of the invention may be advantageously exploited in electronic transaction applications, such as, but not limited to, banking applications and e-commerce.

In one embodiment of the invention these goals are achieved by employing a personal input device capable of communicating with the user's computer terminal via conventional I/O ports (e.g., serial/parallel PC ports, such as USB), and which is capable of establishing a secure channel (e.g., TLS, SSL) over such computer networks (also referred to herein as data networks) and communicate data thereover. The personal input device is preferably designed for allowing it to securely handle secret information such as credit card and PIN (personal identification number) numbers, passwords, secret cryptographic keys, and other such secret information. Most preferably, the personal device is provided with smart card capabilities.

According to another preferred embodiment of the invention the secret information is provided by the user during the transaction in a concealed manner by displaying in the display device of the computer terminal an image comprising randomly located alphanumeric symbols which the user then employ for indicating a sequence of symbols in the secret information by moving the curser over or near the relevant symbols and “clicking” a mouse button, or striking a keyboard key. In this implementation the system delivers the relative locations indicated by the user in the displayed image, which are then used for revealing the secret information according to the locations of the alphanumeric symbols in the image.

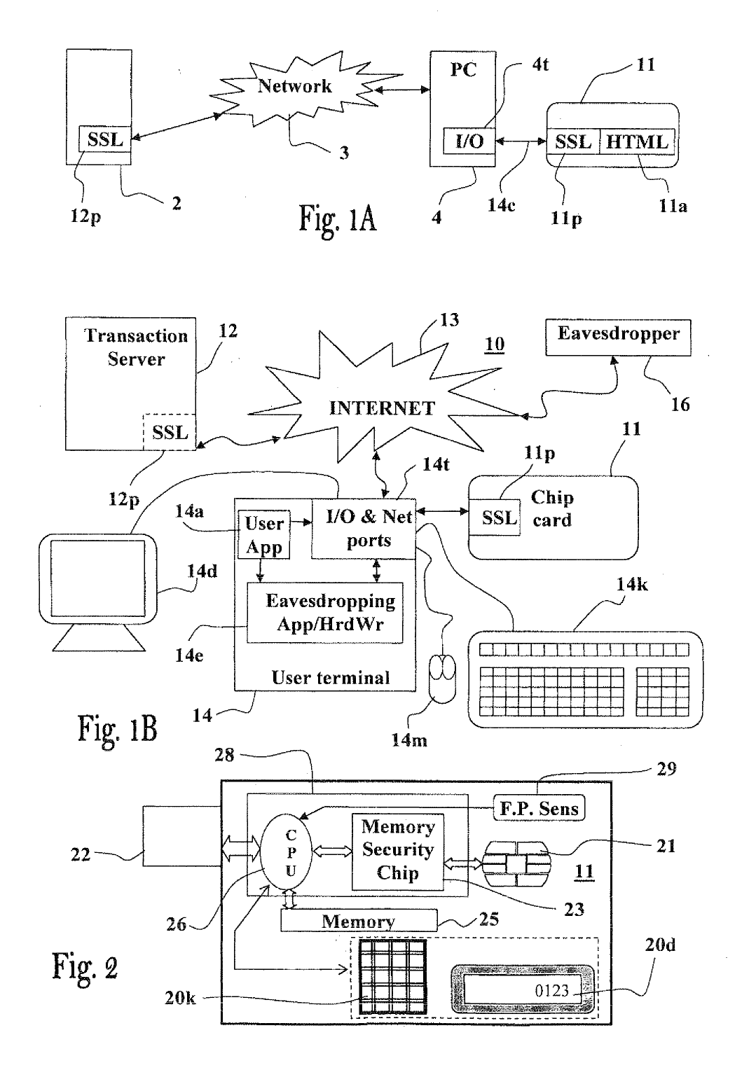

FIG. 1A illustrates in general a preferred embodiment of the invention utilizing a personal apparatus 11 for securely communicating with a remote computer 2 over a computer network 3 (e.g., the Internet) via a (wired or wireless) communication link 14c established with a computer 4, wherein computer 4 is susceptible of being virus infected (e.g., Trojans) or eavesdropped. The secure communication via the insecure computer terminal 4 is achieved by establishing a transport layer secure channel 11p-12p between computers 2 and 4. The secure channel 11p-12p is then employed by application(s) 11a (e.g., client applications) executed in the personal apparatus 11 to securely communicate information with remote computer 2.

FIG. 1B schematically illustrates a preferred embodiment of the invention exemplifying a system 10 for carrying out secure and eavesdrop-free electronic communication via computer terminal 14 connected to data network 13 over a conventional data communication link (LAN, WAN, ATM, and the like). The electronic communication is carried out over computer network 13 (e.g., the Internet) with a transaction server 12, which may be, for example, a banking application server allowing users to carry out financial bank transactions in their bank accounts, or an e-business merchant server allowing users to purchase goods in electronic stores, or any such networking server capable of establishing secured channels with client applications. The user terminal 14 may be a conventional PC machine equipped with a keyboard 14k, display device 14d (e.g., video display) and pointing device 14m (e.g., mouse), connected to it by means of conventional I/O ports and adapters 14t (e.g., parallel/serial port, video adapters, network adapters).

User terminal 14 may further comprises a user application 14a (user client, e.g., internet browser) which is activated and managed by a user and capable of communicating with transaction server 12 over the data network 13. Typically, electronic transactions involve delivery of both secret and non-secret data, most of which may be conventionally performed, for example over SSL secured channel 12p established between the user terminal 4 and the transaction server 12.

For the purpose of this example it is assumed that user terminal 14 further comprises a running eavesdropping application (e.g., Trojan), or eavesdropping hardware 14e, capable of intercepting data transferred via user application 14a and/or I/O ports 14t. Such eavesdropping software/hardware 14e is therefore capable of recording secret information (i.e., credit card numbers) typed by the user via keyboard 14k during the electronic transaction and transferring the same to eavesdropper 16, or allowing it to access it, over data network 13.

In order to prevent interception of secret data during electronic transactions, according to the invention, whenever the user is requested by transaction server 12 to provide such secret data, said secret data is provided to it by means of chip card 11, connected to user terminal 14 via one of its I/O ports 14t (e.g., USB port), over a secured channel (11p, 12p) established between the chip card 11 and transaction server 12.

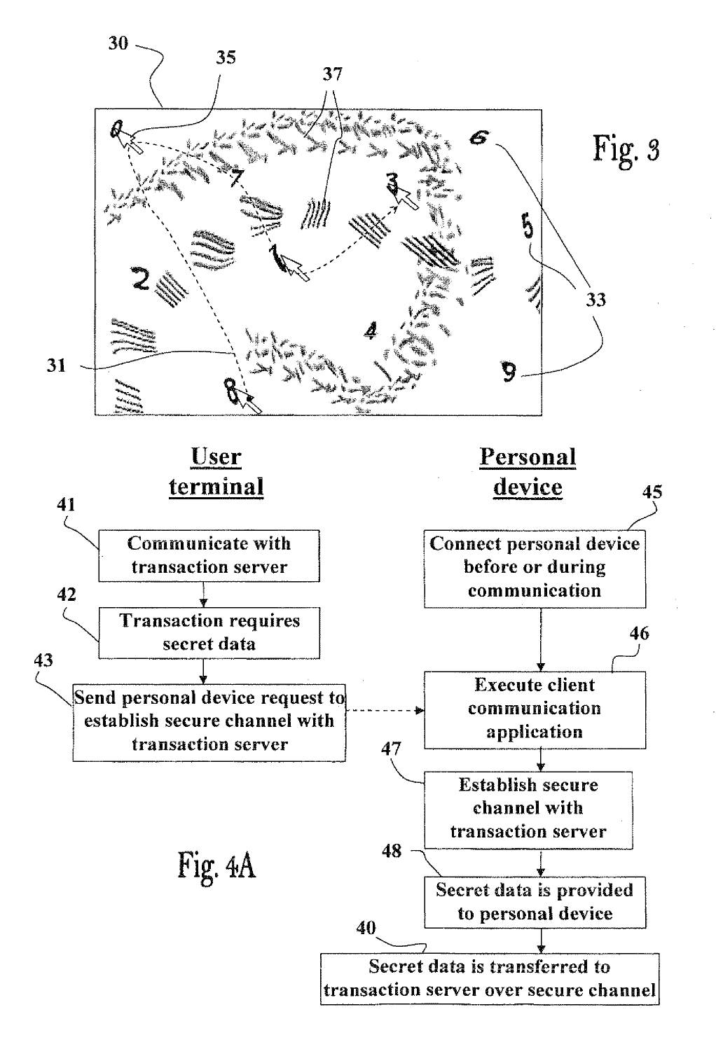

As exemplified in FIG. 2, chip card 11 may be a type of smart card (such as described in WO 2007/138570) having memory security chip 23 and memory 25, that can be communicated via regular ports, such as smart card pad 21 or via conventional USB connector 22. Chip card 11 may further comprise keypad (or keyboard) 20k and display unit 20d (e.g., LCD). Chip card 11 further comprises processing means 26 connected to memory 25 and adapted to read/write data from/to it, receive data from keypad 20k, and to display data in display 20d.

Memory security chip 23 preferably comprise memory unit(s) which may be accessed whenever security conditions (e.g., user authentication) defined therein are satisfied. Memory security chip 23 and processing means 26 are preferably provided in a single integrated circuit chip 28 in order to prevent interception of data (wiretapping) communicated between these units. Memory 25 may be accessed via memory chip 23 and the information stored in it is preferably, but not necessarily, in an encrypted form. Data encryption/decryption is preferably carried out by processing means 26.

In this way, whenever secret data is required by transaction server 12 user application 14a issues a request comprising addressing (e.g., IP address) information for allowing chip card 11 to establish a secure channel (e.g., SSL) with transaction server 12. When such request is received by chip card 11, processing means (26 in FIG. 2) provided therein runs a communication application capable of establishing a secure channel (e.g., SSL network connection). The user can then type the secret information by means of keypad 20k, which may optionally be simultaneously displayed in display unit 20d. The secret information typed by the user is then transferred by chip card 11 to the transaction server 12 over the secure channel (12p-11p) established between them. The communication between the chip card 11 and transaction server 12 is carried out over secure channel (12p, 11p) and therefore the information transferred is not accessible by eavesdropping software/application 14e which may reside in user terminal 14.

Personal apparatus 11 may further include a finger print sensor 29, or other suitable biometric sensing means, for authenticating the one or more users allowed using personal apparatus 11. For this purpose memory 25 may comprise a biometric database including biometric data of authorized users, or alternatively, such biometric database may be stored in transaction server 12 such that the biometric indications obtained by means of biometric sensor 29 may be transferred to transaction server 12 over the secure channel for authenticating users.

Optionally, card 11 may further upload a communication module (not shown) to computer terminal 14 which is used by it for transferring the data from the chip card 11 to data network 13 and via it to communicate with transaction server 12.

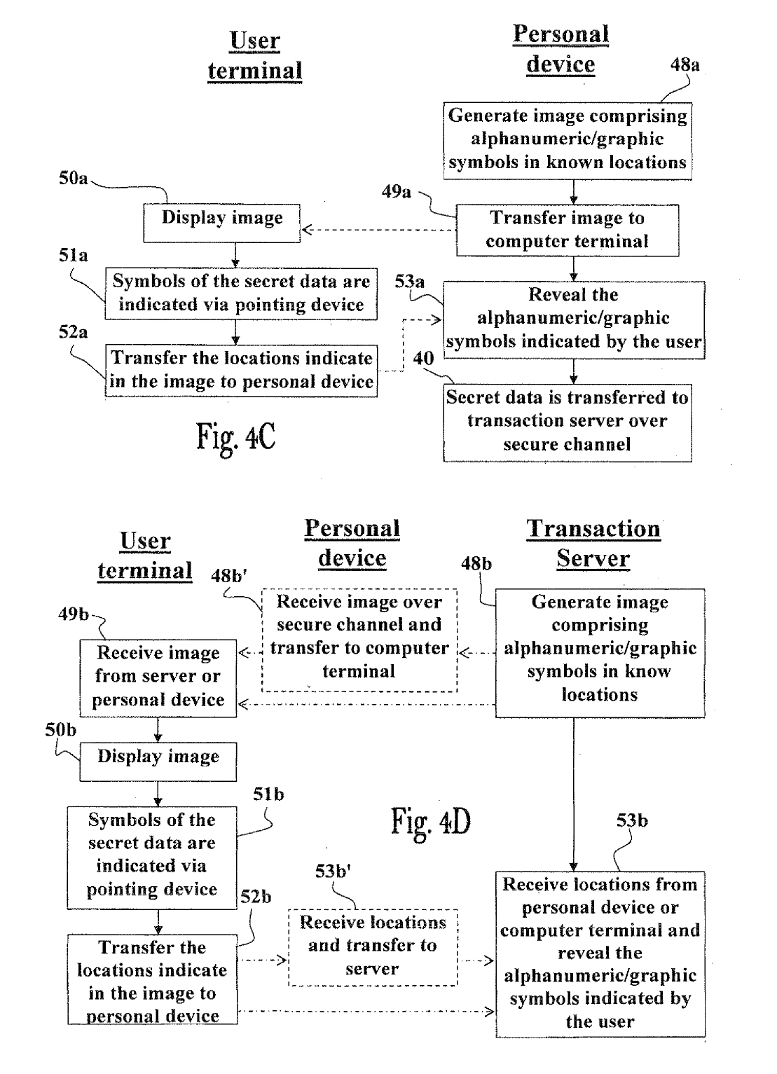

FIG. 4A schematically illustrates the steps involved in securely transferring secret information to transaction server 12 by means of chip card 11 according to one preferred embodiment of the invention. In step 41 the transaction server is approached by the user by means of a networking client application executed by the user's computer terminal, such as but not limited to, Firefox, Internet Explorer, Opera, or the like (e.g., using HTTP protocol or the like). In step 45, the auxiliary device is connected to the computer terminal, (before or during, the communication with the transaction server). In steps 42 and 43, whenever there is a need to transfer secret data a request to establish a secure channel with the transaction server is sent from the computer terminal 14 to the auxiliary device 11, said request includes the information needed to establish the secure channel (e.g., network address of the transaction server, secure channel parameters).

The request to establish secure channel sent to the auxiliary device may be generated by means of a script (e.g., java, perl) received by the client application from the transaction server such that the request is produced by execution of the script by the client application.

Upon receipt of request to establish secure channel, in step 46, the personal apparatus executes a communication application client stored in its memory, said client application extracts the information provided in the request, and in step 47 the data received with the request message is used by the communication application to establish secure communication with the transaction server over the data network.

For example, in case of SSL communication the secured channel is typically established following the SSL message exchange protocol (ClientHello, ServerHello, ServerKeyExchange, ServerHelloDone, ClientKeyExchange, ChangeCiperSpec, Finished, . . . ). Step 46 may further include authentication steps allowing the personal apparatus to authenticate the transaction server, and the transaction server to authenticate the personal apparatus, for example, as provided by the SSL protocol.

In step 48 the secret data needed by the transaction server for carrying out the transaction is entered in the auxiliary device by the user by means of keypad 20k provided therein, and once secure channel (11p-12p in FIG. 1) is established between the auxiliary device and the computer terminal, in step 40 the secret data entered by the user is transferred from the auxiliary device to the transaction server over the secured channel.

FIG. 43 schematically illustrates yet another preferred embodiment of the invention wherein the communication with server (12) is carried via the personal apparatus (11). In this preferred embodiment an interactive session is commenced upon connection of the personal apparatus to the computer machine, as depicted in step 71. Once communication with the personal apparatus (11) is established, in step 81 computer (14) activates a networking software module designed to communicate the personal apparatus to the computer network by means of the computer's resources. Optionally, the networking software module is uploaded from the personal apparatus to the computer once communication is established between them.

In step 72 the personal apparatus activates a client communication application (e.g., internet browser). In step 82 computer terminal executes an interactive viewer application designed to receive and display the communication session between the networking client application and server over the computer network, and to allow the user to interact therewith via the pointing device provided in the computer terminal, as shown in steps 73 and 83. For example, if the client networking application running in the personal apparatus access a web page, the web page is displayed to the user on the display device of the computer terminal by the interactive viewer which allows the user to move the mouse in the display and select objects shown therein by clicking mouse buttons. In this way the user can browse web pages via the interactive viewer which provides the personal apparatus relative locations (e.g., X-Y coordinates) clicked by the user in the display, said relative locations are translated in the personal apparatus into hypertext-selections (e.g., HTML links) according to the location clicked in the display, to which the client communication application response as in regular hypertext web browsing.

In step 75, if secret information is needed during a transaction (banking, e-commerce, or the like), in step 48 the needed information is provided by the user by means of the keypad/keyboard provided in the personal device, which is then securely transmitted to the remote server over the computer network via the secure channel established therebetween.

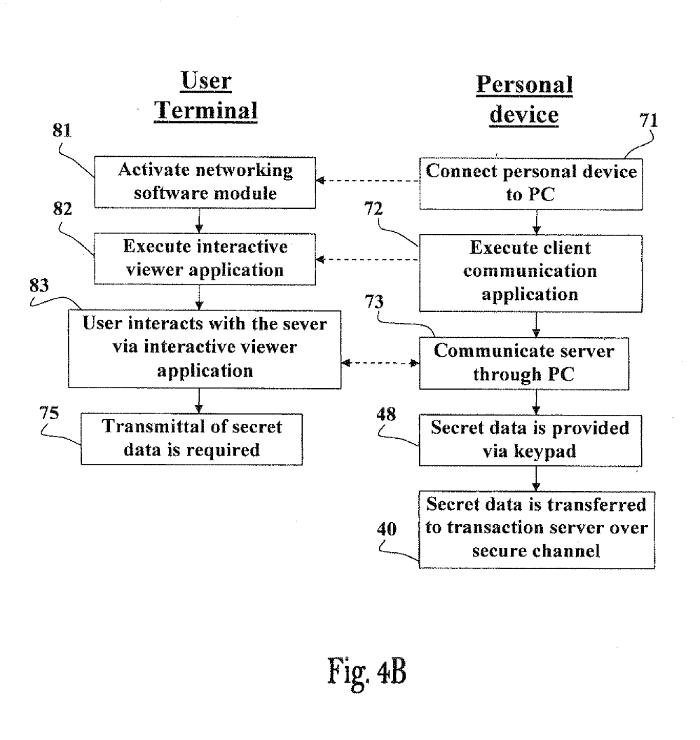

According to another preferred embodiment of the invention the secret information is provided by the user in a concealed manner by means of pointing device 14m, and therefrom it is transferred to transaction server 12. In order to conceal the secret data provided by the user it is provided by means of an image provided to user terminal 14 by chip card 11, or by transaction server 12. The image 30 (exemplified in FIG. 3, also referred to herein as data entry image) provided by chip card 11, or transaction server 12, comprises numeric and/or alphabetic symbols 33 randomly located in image 30, and it is displayed in display device 14d. Data entry image preferably comprises additional displayable objects, such as logos, images, and/or background textures or wallpapers. While alphanumeric symbols 33 are randomly located in data entry image 30, these locations are recorded and maintained in memory of the device/system (e.g., auxiliary device or transaction server) in which the data entry image was generated for revealing the secret data indicated by the user in the future, upon receipt of the locations clicked in the image by the user.

After data entry image 30 is displayed in the display device 14d the user transfers the secret data (i.e., PIN) to chip card 11 by placing the cursor 35 over or near the alphanumeric symbols 33 shown therein, in the sequence of their appearance in said secret data, and “clicking” the pointing device 14m. Each time the pointing device is “clicked” in the area of the data entry image 30, the relative location (X-Y coordinates) of cursor 35 in image 30 is recorded in memory of the computer terminal. The relative locations clicked in the displayed image are then used by the personal apparatus or the server to reveal the secret data the user provided.

For example, if during an electronic transaction the user is requested by transaction server 12 to provide a PIN, said. PIN is “8013”, the user moves the cursor to the locations of the digits “8”, “0”, “1”, and “3”, appearing in data entry image 30, as demonstrated by the dotted lines 31 shown in FIG. 3, and clicks the pointing device 14m over or near each symbol.

Data entry image 30 may be generated by transaction server 12 or by chip card 11, and each time secret information from the user is needed a new such data entry image is produced and displayed in display device 14d. If image 30 is produced by chip card 11 the relative locations in which the user “clicked” pointing device 14m in image 30 are used by processing means 26 to determined the symbols in the secret data according to their proximity to the symbols in data entry image 30. Thereafter, chip card 11 transfers the secret data as revealed from the “clicked” locations to transaction server 12 over the secured channel established therebetween over data network 13. Of course, in such case the keypad 20k and display unit 20d are not necessarily needed in chip card 11.

FIG. 4C exemplifies the steps involved in securely receiving the secret data from the user by means of a data entry image generated by the auxiliary device. The steps shown in. FIG. 4C may be carried out as part, or instead of, step 48 shown in FIGS. 4A and 4B. In this example in order to receive the secret data from the user, in step 48a the auxiliary device generates a data entry image (e.g., 30 in FIG. 3) and in step 49a transfers it to the computer terminal. As explained above, the data entry image comprises randomly located alphanumeric and/or graphic symbols which locations in the data entry image are recorded in the memory of the auxiliary device upon generation of said image, and optionally additional displayable objects (images, logos, backgrounds, etc.).

In step 50a the computer terminal receives the data entry image produced by the auxiliary device and displays it in its display device. Next, in step 51a, the user places the cursors over alphanumeric/graphic symbols displayed in the data entry image and clicks the pointing device (or a keyboard key) to indicate it being part of the needed secret data. In step 52a the sequence of locations clicked by the user in the data entry image are transferred to the auxiliary device, which in step 53a receives the same and then reveals (decipher) the secret data indicated by the user by means of the pointing device. The secret data indicated by the user is revealed by the auxiliary device by determining the proximity of the locations clicked by the user in the area of the data entry image to the recorded locations of the randomly located alphanumeric/graphic symbols in the data entry image, as recorded in the auxiliary device memory. Thereafter, in step 40, the revealed secret data is transferred from the auxiliary device to the transaction server over the secured channel established therebetween.

As demonstrated in FIG. 4C, the secret data used in the system of the invention may be expanded to include graphic and/or alphanumeric symbols, which are not essentially included in the standard keyboards. For example, the secret data may comprise both graphic and alphanumeric symbols as follows—“G∇23♡4%★s”, which can be easily located and displayed in the data entry image as discussed hereinabove.

If data entry image 30 is produced by transaction server 12, the relative locations “clicked” by the user are transferred to transaction server 12 through chip card 11, or by user application 14a, which is then used by transaction server 12 to reveal the symbols in the secret data. Therefore, in this case the electronic transaction may be carried our securely and eavesdrop-free without requiring chip card 11.

FIG. 4D exemplifies the steps involved in securely receiving the secret data from the user by means of a data entry image generated by the transaction server. Similarly, the steps shown in FIG. 4D may be carried out as part, or instead of, step 48 shown in FIGS. 4A and 4B. In this example in order to receive the secret data from the user, in step 48b the transaction server generates a data entry image (e.g., 30 in FIG. 3) and transfers it to the computer terminal. As explained above, the data entry image comprises randomly located alphanumeric and/or graphic symbols which locations in the data entry image are recorded in the memory of the transaction server upon generation of said image. Of course, the data entry image may optionally comprise additional displayable objects (images, logos, backgrounds, etc.). As indicated by the dashed/dotted lines, the data image entry may be transferred directly from transaction server to computer terminal, or optionally (indicated by dashed text box) via the auxiliary device (i.e., the personal apparatus), as shown in step 48b′. In both cases, however, the data entry image may be sent over a secure channel (e.g., SSL), but not necessarily.

In step 49b the computer terminal receives the data entry image produced by the transaction server and displays it in its display device in step 50b. Next, in step 51b, the user places the cursors over alphanumeric/graphic symbols appearing in the data entry image and clicks the pointing device (or a keyboard key) to indicate it being part of the sequence of the needed secret data. In step 52b the locations clicked by the user in the area of the data entry image are transferred to the transaction server, which in step 53b receives the same and then reveals the secret data indicated by the user by means of the pointing device. As indicated by the dashed/dotted lines, the clicked locations data may be transferred directly from the computer terminal to the transaction server, or optionally (indicated by dashed text box) via the auxiliary device (i.e., the personal apparatus), as shown in step 53b′. In both cases, however, the clicked locations data is preferably sent over a secure channel (e.g., SSL), but not necessarily.

As explained above, in a similar fashion, the secret data indicated by the user is revealed by the personal apparatus by determining the proximity of the locations clicked by the user in the area of the data entry image to the recorded locations of the randomly located alphanumeric/graphic symbols in the data entry image, as recorded in the memory of the transaction server.

Accordingly, this preferred embodiment of the invention advantageously allows users to securely transfer secret information through insecure computer terminals by means of a data entry image without requiring use of the personal apparatus, such as chip card 11. The secret information may be, but not limited to, a PIN number, a password, ID, credit card number, account number, and/or instructions to perform transactions, all of which may be delivered in a concealed manner (e.g., as X-Y coordinates) directly to the transaction server 12. It should be appreciated that since the secret data is transferred in a concealed manner e.g., in a form of X-Y coordinates in an image, this method of the invention may be also employed for carrying out transactions over insecure channels, namely, without establishing a secure channel, and without requiring the personal apparatus.

Data entry image 30 is preferably a type of image resistant to OCR (Optical Character Recognition) for preventing the secret data transferred via pointing device 14m from being revealed by potential eavesdroppers 14e and 16. For this purpose the symbols randomly located in image 30 may be distorted or obscured, and image 30 may further include background marks/images 37 (as in CAPTCHA challenges) for preventing them from being analyzed by machine reading applications.

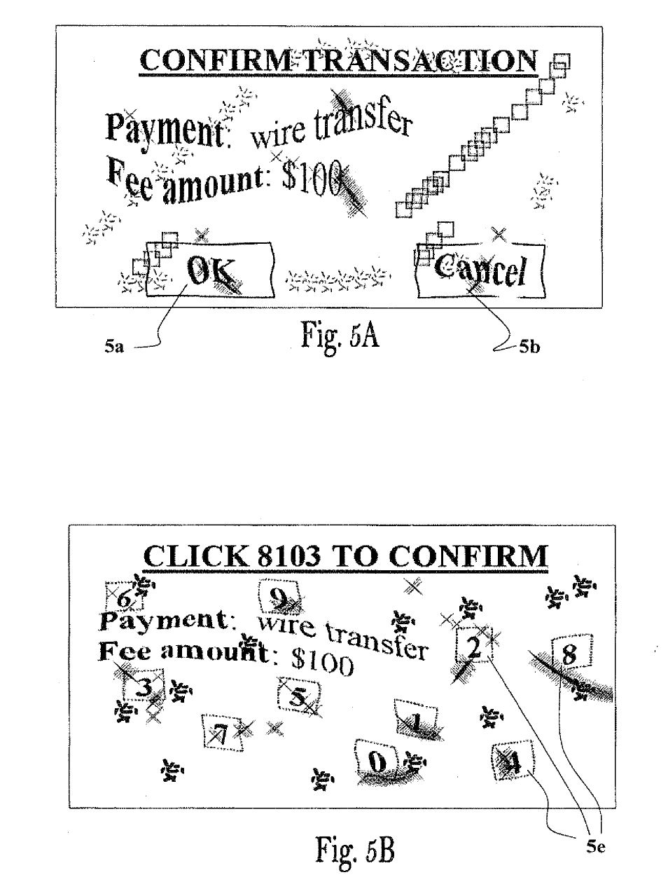

This principle for delivering secret data in a concealed manner may be further employed for requesting user's confirmation in a concealed manner, and thereby to conceal the details of transaction performed from potential eavesdroppers. For example, before completing the transaction, when user's confirmation is needed, the transaction server 12, or the chip card 11, produces a confirmation image comprising the details of the requested transaction. The text in the produced image is preferably provided in a machine non-readable format (e.g., distorted, obscured, in a CAPTCHA format). The confirmation image may further comprise confirm/abort text, such as “YES” “NO”, or the like (5a and 5b in FIG. 5A), to be used by the user for confirming or aborting the electronic transaction, as exemplified in FIG. 5A. The user wishing to confirm the electronic transaction will then move the cursor to the graphic representation of the “YES” text in the confirmation image and then click it with the pointing device or strike a keyboard key. The relative location of the cursor in the area of the confirmation image will then be used by the transaction server 12, or by the chip card 11, to reveal whether the electronic transaction was confirmed or aborted by the user.

Alternatively, as exemplified in FIG. 5B, the confirmation image may further comprise a set of randomly located alphanumeric symbols (5e) and instructions to click a certain confirmation sequence of symbols e.g., “CLICK 8103 TO CONFIRM” to confirm the transaction. When the user confirms the electronic transaction the user clicks on the confirmation symbols appearing in the image and the relative locations of the clicked points in the area of the confirmation image in the image are used to reveal whether the user confirmed or aborted the transaction.

As demonstrated in FIGS. 5A and 5B, the confirmation images are generated in an OCR resistant form (in a machine non-readable form, such as in CAPTCHA challenges), in order to prevent computerized analysis thereof by eavesdropping software or hardware. Accordingly, since the data is received from the user in a concealed form, as a set of relative locations in an image which is produced in a machine non-readable format, even if data from the user is intercepted by potential eavesdroppers, they will not be able to reveal its content.

This preferred embodiment of the invention may be also employed for preventing unauthorized entities from tampering with the transaction data. For example, eavesdropper 16 may be able to alter the transaction details (e.g., change bank account details or fee amount) by tampering with the data handled by user application 14a. Such tampering may be prevented if the transaction details and instructions are communicated to, and from, the user by means of OCR resistant images generated by the transaction server 12 (or personal apparatus 11) to include the transaction information and request user's confirmation by “clicking” certain locations in the image.

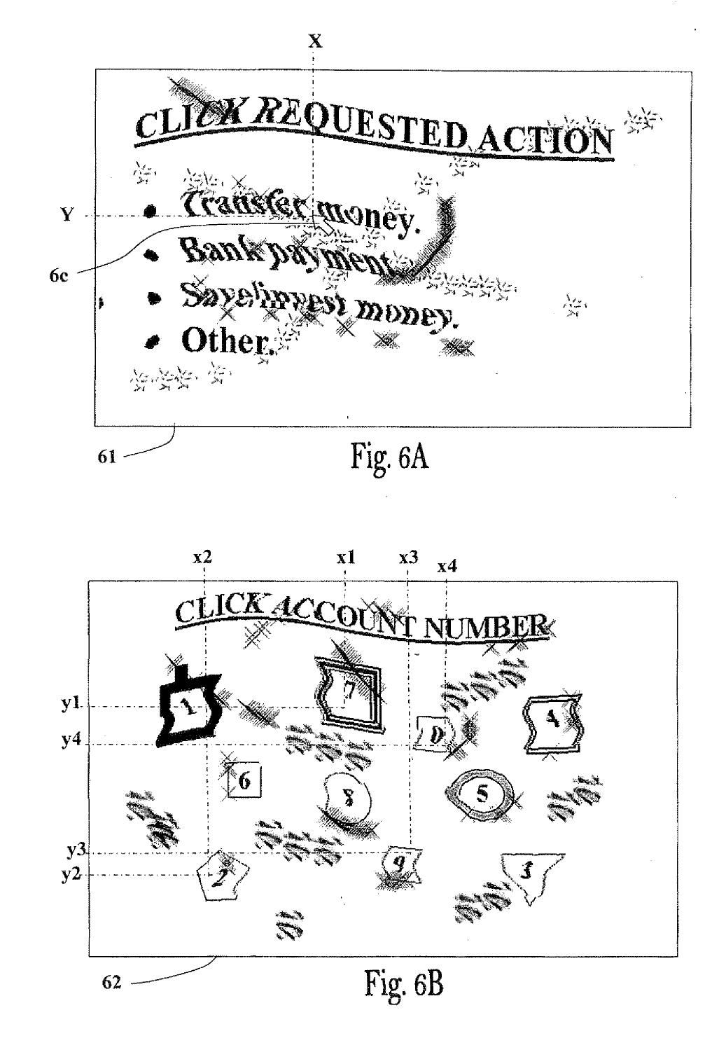

For example, an electronic transaction may be commenced by such OCR resistant image, generated by the transaction server 12 and displayed to the user by user terminal 14, comprising a list of possible operations e.g., transfer money from my account, bank payment, save/invest money, and the like, and textual instructions requesting the user to “click” over a requested operation appearing in the displayed image as in image 61 shown in FIG. 6A. Once an operation is selected the X-Y coordinates of the operation clicked by the user (6c) in the image 61 are sent to the transaction server 12 which translates said X-Y coordinates to the requested operation (e.g., transfer money from my account) and in response generates a new OCR resistant image to be displayed to the user requesting specific details (e.g., account number to which the money should be transferred) regarding the requested operation, and instructions requesting the user to “click” with the mouse over the relevant options, or alphanumeric symbols, appearing in the image, as exemplified in image 62 shown in FIG. 6B. The X-Y locations “clicked” by the user (for account number “7290” [(x1,y1),(x2,y2),(x3,y3),(x4,y4)], as shown in FIG. 6B) in the displayed image (62) are then transferred to the transaction server 12 which accordingly reveal the transaction details (e.g., transfer to account No. 7290) and generates a new OCR resistant image containing the selected operation and it details and requesting user's confirmation by clicking a sequence of alphanumeric symbols appearing in the displayed image constituting user's secret data (e.g., PIN, or password). The X-Y locations clicked by the user in the displayed image are transferred to the transaction server which then reveals the alphanumeric sequence clicked by the user. The alphanumeric sequence is then employed for verifying user's identity and for acknowledging the transaction by verifying that the clicked alphanumeric sequence is the requested secret information of the user.

Such electronic transaction of the invention are preferably, but not necessarily, carried out over a secure channel, for example, by establishing SSL connection between the transaction server and the user terminal. As will be appreciated, this method of the invention effectively allows carrying out eavesdrop-free and tamper-free electronic transactions over insecure communication channels, such as the Internet, and by means of insecure publicly available computer terminals.

Carrying out electronic transactions by means of the personal apparatus of the invention may be advantageously employed for securely registering and electrically signing each transaction carried out by the user with the personal apparatus. Such secure registration and signature of user's transactions provides the user means for verifying transactions carried out and for recording the approval of the transaction server for transactions performed.

As discussed hereinabove, information may be transferred in a concealed manner by means graphical presentation directly between the communicating parties, or between user's computer terminal and an personal apparatus of the invention. In the latter case, the information may be entered by means of a keypad/keyboard integrated into the personal apparatus or by means of a keypad/keyboard which may be connected directly to the personal apparatus.

The secret information received by the personal apparatus, either directly by means of a keypad/keyboard connected to it or from the computer terminal in a concealed form by means of graphical presentation, is transferred to the transaction server over the secure channel established between personal apparatus and the transaction server. Additionally or alternatively, the secret data may be transferred directly to the transaction server by means of a mobile communication device (e.g., cellular phone), for example, by means of a SMS message.

It should be clear that the communication between personal apparatus 11 and data network 13 may be obtained in different ways, without employing a computer terminal 14, for example, by means of wireless communication devices such as, but not limited to, PDAs and cellular phones, to which the personal apparatus of the invention may be physically or wirelessly linked. Alternatively, the personal apparatus may comprise network communication means allowing it to communicate directly with the data network.

In one preferred embodiment of the invention the approval of the user of the transaction's details/data which been entered by the user is also carried out in a concealed manner by means of a graphical presentation of the details/data in a confirmation image. For example, after the user has provided the data, the personal apparatus (or the transaction server) generates and sends a graphical confirmation image to be displayed to the user, which contains the transaction details/data as received by the personal apparatus (or server), together with (on the same conformation image) a random code generated by the apparatus, which will be displayed in a machine non-readable format (e.g., distorted, obscured, in a CAPTCHA format). The user can identify the code, and should enter that code (from the keyboard or by clicking the mouse on images displayed in the confirmation image which represents a virtual keyboard) in order to approve to the apparatus (or server) the correction of the received data. This method for obtaining users' approval overcomes the problem that the Trojan may alter the data sent to the apparatus (or server), while displaying to the user the data as entered. In such case, the apparatus (or server) will not receive the random code the apparatus (or server) has generated, since the Trojan can't read it.

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1. A system for carrying out secure electronic communication over a computer network via a computer susceptible of being virus infected or eavesdropped, the system comprising: a first computer operatively coupled to said computer network, said first computer is susceptible of being virus infected or eavesdropped, a second computer operatively coupled to said computer network, and a personal apparatus comprising: processing means, one or more memory devices, keyboard or keypad means, one or more interfacing means suitable for exchanging information with said first computer, and a communication software having cryptographic capabilities stored in said one or more memory means,
wherein the processing means and at least one of the one or more memory devices are integrated into a single integrated circuit chip such that interception of data transferred therein is prevented,
and wherein said personal apparatus is adapted to establish a secure channel with said second computer over said computer network, and to receive confidential data from a user via said keyboard or keypad means and transfer said confidential data, or portions thereof, to said second computer over said secure channel.

2. The system according to claim 1 wherein the personal apparatus further comprises display means, said personal apparatus is adapted to display the confidential data received from the user in said display means.

3. The system according to claim 1 wherein the personal apparatus further comprises smart card capabilities.

4. The system according to claim 1 wherein the interfacing means utilizes conventional serial/parallel and/or wireless data communication ports and protocols.

5. The system according to claim 1 wherein the personal apparatus is further adapted to generate data entry images comprising alphanumeric and/or graphic symbols placed in random locations therein, wherein said data entry images are used for transferring secret data in a concealed form by transferring relative locations of alphanumeric and/or graphic symbols appearing in said data entry images as indicated by a user.

6. The system according to claim 1 wherein the second computer is further adapted to generate data entry images comprising alphanumeric and/or graphic symbols placed in random locations in it, wherein said data entry images are used for transferring secret data in a concealed form by transferring relative locations of alphanumeric and/or graphic symbols appearing in said data entry images as indicated by a user.

7. The system according to claim 1 wherein the personal apparatus is further adapted to encrypt/decrypt data stored in its memory devices.

8. The system according to claim 1 wherein the first computer further comprises an interactive viewer adapted to display the communication session carried out by said communication software by means of images, wherein the interactive viewer is further adapted to receive data from a user by means of a pointing device provided in the first computer, and to transfer said data to the personal apparatus in form of relative locations in an image displayed in said interactive viewer.

9. The system according to claim 5, wherein the displayed images are in a machine non-readable form and OCR resistant.

10. A method for carrying out secure electronic communication between a first computer and a second computer over a computer network, wherein said first computer is susceptible of being virus infected or eavesdropped, comprising:
linking a personal apparatus to said first computer, said personal apparatus comprising processing means, one or more memory devices, keyboard or keypad means, one or more interfacing means suitable for exchanging information with said first computer, and a communication software having cryptographic capabilities stored in said one or more memory means, wherein the processing means and at least one of the one or more memory devices are integrated into a single integrated circuit chip such that interception of data transferred therein is prevented,
activating said communication software in said personal apparatus;
activating a networking software module in said first computer, said networking software module is adapted to provide said personal apparatus access to network resources provided in said first computer;
establishing communication with said second computer over said computer network by means of said communication software and said networking software module;
establishing a secure channel between said communication software and said second computer over said computer network; and
whenever needed, receiving confidential data from a user via said keyboard or keypad means and transferring said confidential data, or portions thereof, to said second computer from said personal apparatus over said secure channel.

11. The method according to claim 10 wherein the personal apparatus further comprises display means, and wherein the method further comprises displaying the confidential data received from the used in said display means.

12. The method according to claim 10 further comprising:
activating an interactive viewer in said first computer, said interactive viewer is adapted to display the communication session carried out by said communication software by means of images;
generating a data entry image by the personal apparatus or by the second computer, said data entry image comprises alphanumeric and/or graphic symbols pieced in random locations, the relative locations of which in said data entry image are recorded in said personal apparatus or server;
displaying said data entry image in a display device provided in the first computer by means of said interactive viewer;
receiving in said first computer relative locations of a sequence of alphanumeric and/or graphic symbols appearing in said data entry image;
transferring said relative locations to said personal apparatus and/or second computer; and
determining the data provided by the user according to the proximity of said relative locations to the locations of the alphanumeric and/or graphic symbols recorded in said personal apparatus or second computer.

13. The method according to claim 12 wherein the displayed images are in a machine non-readable form and OCR resistant.

14. The method according to claim 12 further comprising sending the determined data from said personal apparatus to the second computer over the secure channel, if so needed.

15. A method according to claim 10, wherein the computer network is a TCP/IP network or the Internet.

16. A method according to claim 15 wherein the secure channel is implemented using the SSL or TLS protocol.

17. A method according to claim 10 wherein the data link between the first computer and the personal apparatus is established through conventional serial or parallel computer ports, or by means of wireless communication.

18. A method according to claim 10 wherein the networking software module is provided to the first computer by the personal apparatus after linking between them.

19. A Personal apparatus comprising processing means, keyboard or keypad means, one or more memory devices, one or more interfacing means suitable for exchanging information with a computer, a communication software having cryptographic capabilities stored in said one or more memory means, wherein the processing means and at least one of the one or more memory devices are integrated into a single integrated circuit chip such that interception of data transferred therein is prevented,
wherein said personal apparatus is adapted to communicate via said one or more interfacing means with a computer terminal coupled to a computer network, to establish a secure connection with another computer over said computer network by means of said communication software, to receive confidential data from a user via said keyboard or keypad means and transfer said confidential data, or portions thereof, to said second computer over said secure channel.

20. The personal apparatus according to claim 19 further comprising display means, wherein said personal apparatus is further adapted to display the confidential data in said display means.

21. The apparatus according to claim 19 further comprising data entry images generating means, said data entry images comprise alphanumeric and/or graphic symbols placed in random locations therein, wherein said random locations are recorded in said personal apparatus, and wherein said data entry images are used for transferring secret data received from a user by transferring relative locations of a sequence of alphanumeric and/or graphic symbols appearing in said data entry image as indicated by a user.
